(19) United States
(12) Patent Application Publication
(10) Pub. No.: US 2026/0104875 A1
(43) Pub. Date: Apr. 16, 2026

(54) AUTOMATED APPLICATION DEPLOYMENT USING ABSTRACTED CONFIGURATION FILES

(71) Applicant: Notion Labs, Inc., San Francisco, CA (US)

(72) Inventor: Arpeet Sundar Kale, San Jose, CA (US)

(21) Appl. No.: 19/077,859

(22) Filed: Mar. 12, 2025

Related U.S. Application Data
(60) Provisional application No. 63/708,097, filed on Oct. 16, 2024.

(51) Int. Cl. G06F 8/60; G06F 8/71; G06F 11/34; H04L 43/10; H04L 47/125

(52) U.S. Cl. CPC G06F 8/60; G06F 8/71; G06F 11/3466; H04L 43/10; H04L 47/125

(57) ABSTRACT

The present disclosure provides systems and methods for the automated deployment, scaling, and management of applications using abstracted configuration files. A user may configure an abstracted configuration file that is received by an automated deployment platform configured to automatically manage the remainder of the application deployment process on behalf of the user. For example, the automated deployment platform may generate a deployment manifest that directs an application deployment system to modify an application, generate an account for permissions management, configure a load balancer, and/or monitor the performance of the application.

### CROSS-REFERENCE TO RELATED APPLICATION(S)

This application claims priority to and the benefits of U.S. Provisional Application No. 63/708,097, titled “SYSTEM FOR AUTOMATED AND ABSTRACTED KUBERNETES DEPLOYMENT” filed on Oct. 16, 2024. The content of the aforementioned application is herein incorporated by reference in its entirety.

### BACKGROUND

Software deployment refers to all the activities that make a software system available for use. The general deployment process consists of several interrelated activities with possible transitions between them. These activities can occur on the producer side, on the consumer side, or both. Because every software system is unique, the precise processes or procedures within each activity can hardly be defined. Therefore, “deployment” should be understood as a general process that has to be customized according to specific requirements or characteristics.

A container orchestration system is a system for automating software deployment, scaling, and management. One such popular tool is Kubernetes, which is an open-source project originally designed by Google and now maintained by a worldwide community of contributors. Kubernetes defines a set of building blocks (“primitives”) that collectively provide mechanisms that deploy, maintain, and scale applications based on central processing unit (CPU), memory, or custom metrics. Kubernetes is loosely coupled and extensible to meet the needs of different workloads. The internal components as well as extensions and containers that run on Kubernetes rely on the Kubernetes application programming interface (API). The platform exerts its control over compute and storage resources by defining resources as objects, which can then be managed as such.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is an example application deployment framework for deploying an application using an automated deployment platform.

FIG. 5 is a sequence diagram illustrating an example sequence for monitoring and deploying an application.

FIG. 6 is an illustration of an example abstracted configuration file.

FIG. 7 is a flow diagram illustrating an example method for management of application deployment.

FIG. 8 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for the automated deployment, scaling, and management of applications using abstracted configuration files. The increasing adoption of container orchestration systems has introduced complexity into the service deployment process, requiring engineers to possess deep knowledge regarding these technologies and thereby slowing down deployment workflows. Existing tools for abstracting deployment workflows still require users to manually configure several separate files and learn many intricacies of a container orchestration system or other application deployment system. Furthermore, existing tools do not allow for simultaneous automation of the management of an application after initial deployment (e.g., managing permissions, load balancing, networking, performance monitoring) alongside the initial configuration of an application deployment system. Thus, these tools are limited in their ability to help engineers automate application deployment and management.

The present technology overcomes the limitations of these existing tools by acting as an automated deployment platform for automatically directing an application deployment system and managing post-deployment activities associated with an application using a single abstracted configuration file received from a user. Because the user need only learn the properties of the abstracted configuration file, which may be written in a common data serialization language (e.g., YAML), the time the user spends on learning an application deployment system and manually managing an application may be greatly reduced. Additionally, deployment via an abstracted configuration file and automated deployment platform improves computational efficiency, as the number of necessary configuration files is reduced, thus saving computational resources on storing and copying these files, especially over the course of deployment for multiple applications. For example, an abstracted configuration file as disclosed herein may be repurposed to deploy multiple different applications with a reduced number of modifications, therefore requiring few computational resources to be repeatedly spent on configuring several unique deployments.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

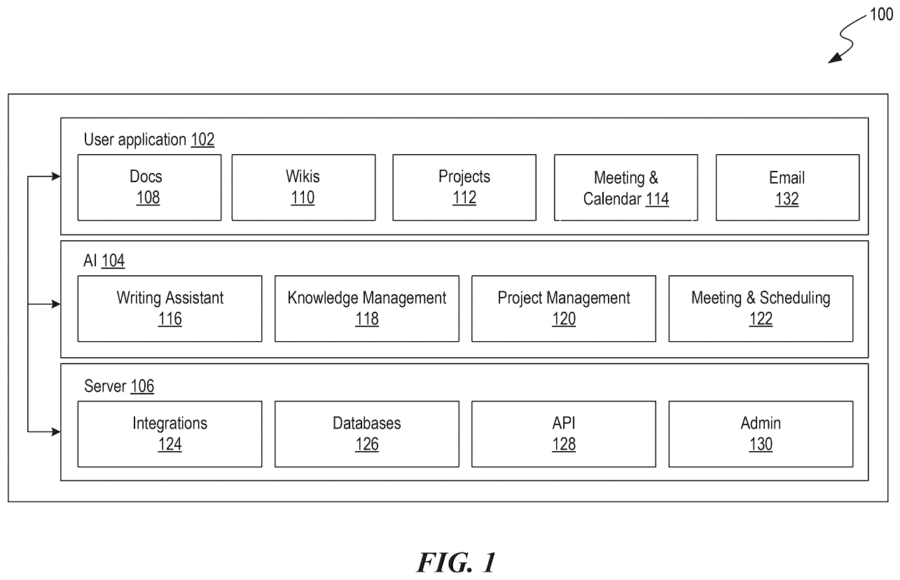

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

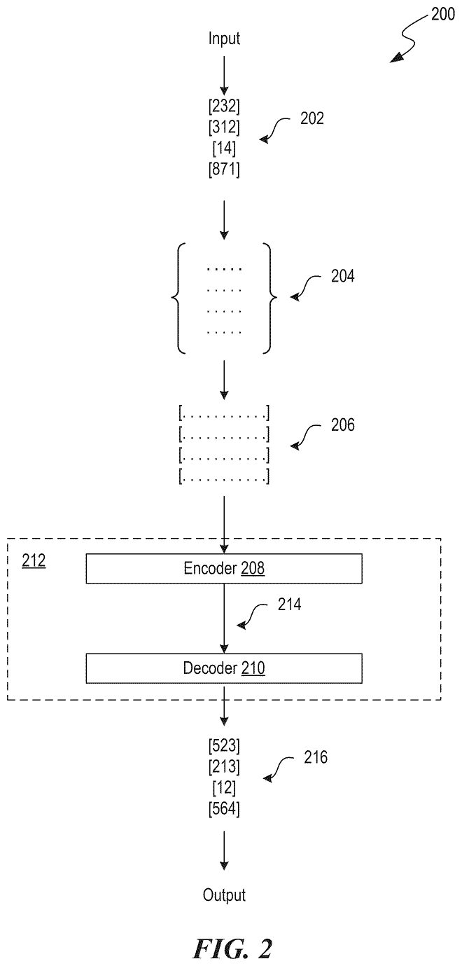

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

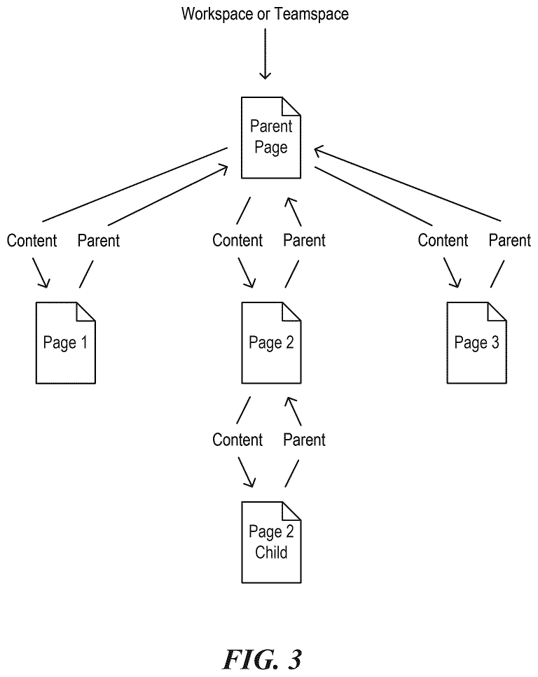

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Application Deployment Frameworks

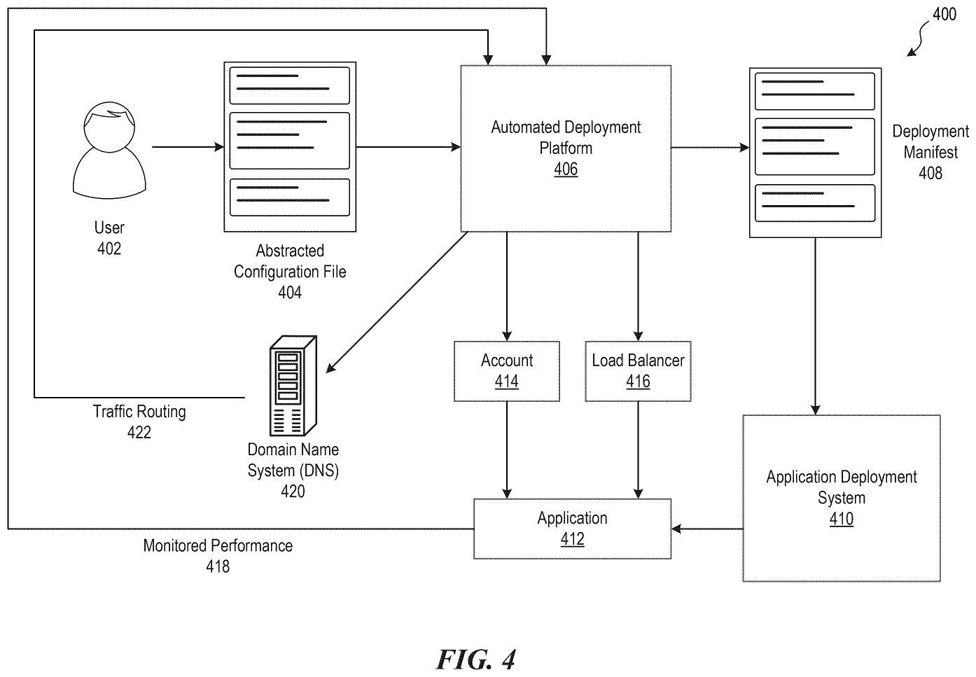

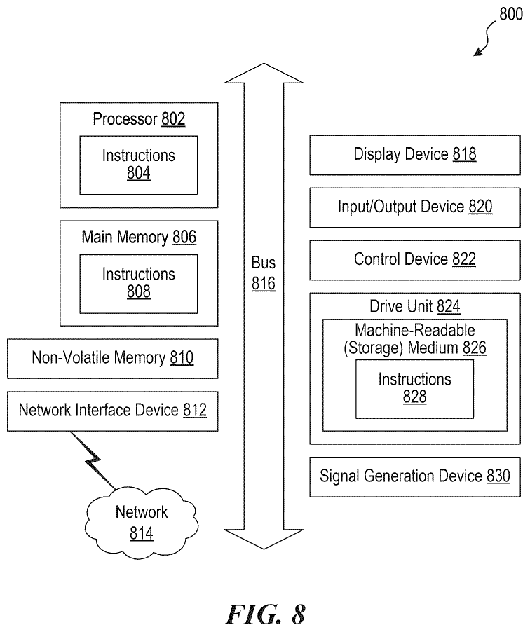

FIG. 4 is an example application deployment framework 400 for deploying an application 412 using an automated deployment platform 406. The application deployment framework 400 includes a user 402, abstracted configuration file 404, automated deployment platform 406, deployment manifest 408, application deployment system 410, application 412, account 414, load balancer 416, and domain name system (DNS) 420. The application deployment framework 400 may be implemented using the computer system illustrated and described in more detail with reference to FIG. 8. Likewise, implementations of the application deployment framework 400 can include different and/or additional components or can be connected in different ways.

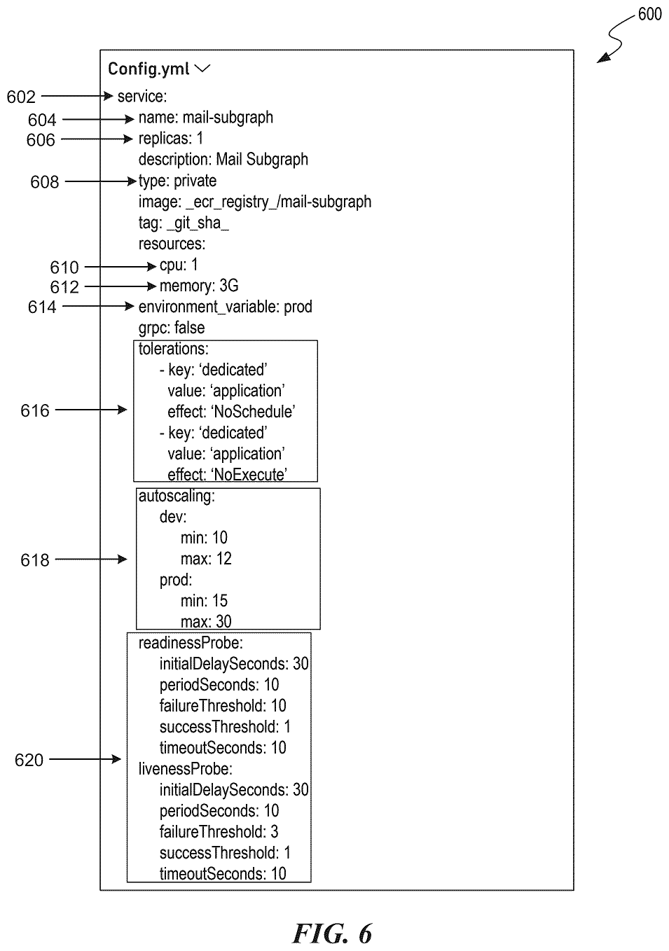

The user 402 represents an individual or entity configuring an application 412 for deployment. In order to deploy the application 412 without manually operating an application deployment system 410 and configuring the relevant parameters individually, the user 402 instead configures an abstracted configuration file 404. The abstracted configuration file 404 is a file written in a data serialization language (e.g., YAML, XML, or JSON), which specifies a plurality of properties associated with the application 412 to be deployed by the application deployment system 410. In some embodiments, the plurality of properties specified by the abstracted configuration file 404 includes the properties described in relation to FIG. 6 below.

In some embodiments, the plurality of properties specified by the abstracted configuration file 404 includes an environmental variable (e.g., indicating whether the application is to be deployed in a development environment, a staging environment, or a production environment). The environmental variable corresponds to an environment in which the application 412 is to be deployed by the application deployment system 410. For example, the environment may be a cloud data center located in a specific geographic location and may have associated region-specific setting(s) for deploying an application 412 in that environment.

The abstracted configuration file 404 is received by an automated deployment platform 406, which automatically manages the remainder of the application deployment process on behalf of the user 402. The plurality of properties specified in the abstracted configuration file 404 represent the user's 402 instructions for deployment of the application 412 but do so at a high level of abstraction that is not readable by the application deployment system 410. Thus, the automated deployment platform 406 generates a deployment manifest 408 for the application deployment system 410 that translates the high-level instructions specified in the abstracted configuration file 404 into more specific instructions that are readable by the application deployment system 410. In some embodiments, the application deployment system 410 is a platform designed for automating the deployment, scaling, and management of containerized applications such as Kubernetes or another similar platform. As the automated deployment platform 406 may manage the application deployment process (including after initial deployment, as described in more detail below) using as little as a single abstracted configuration file 404 as input, computational resources may be conserved by reducing the amount of data required to store and copy configuration files for application deployment. Using the automated deployment platform 406 for multiple unique deployments multiplies this conservative effect, as one abstracted configuration file 404 can be used for multiple deployments with little modification.

In some embodiments, the deployment manifest 408 directs the application deployment system 410 to modify the application 412 from a current state to a desired state at a controlled rate. For example, the current state of the application 412 may be a state of not being deployed and the desired state may be a state in which the application 412 is deployed (e.g., in the environment specified by the environmental variable). In such embodiments, the application deployment system 410 gradually deploys parts of the application 412 and/or gradually uploads or accesses resources for deploying the application 412 according to the controlled rate determined by the deployment manifest 408. As another example, the current state of the application 412 may be a state of deployment, but the desired state may be a different state of deployment (e.g., different environment, different number of central processing units (CPUs) used for deployment). In such embodiments, the application deployment system 410 gradually modifies the application 412 until it reaches the desired state, again according to the controlled rate determined by the deployment manifest 408.

In some embodiments, the deployment manifest 408 defines parameters for a container in the application deployment system 410. For example, the parameters may include an image, a port, an environmental variable as described above, or a security context (e.g., definition of privilege and/or access control settings). In these and other embodiments, the deployment manifest 408 may also specify a deployment policy for the application deployment system 410. For example, the deployment policy may be a resource limit indicating the maximum computing resources available to the application 412 or a scaling policy for the application, such as the controlled rate of change described above or an autoscaling threshold beyond which the application deployment system 410 is prohibited from scaling the application 412.

In some embodiments, the deployment manifest 408 additionally applies region-specific settings associated with the environment to the application deployment system 410. For example, the automated deployment platform 406 may be configured to associate a certain environmental variable (e.g., DEV, STAGE, or PROD indicating a development, staging, or production environment, respectively) with deployment of the application 412 in a specific environment, or a specific cloud data center located in a specific geographic location (e.g., an Amazon Web Services (AWS) cloud server in San Francisco). Each environment will require unique deployment procedures to successfully deploy the application 412 in that environment and/or an entity interested in the deployment of the application 412 (e.g., a project manager) may have a desired deployment procedure unique to each environment. The region-specific settings ensure the application deployment system 410 is configured to successfully deploy the application 412 in the desired environment in a manner consistent with any applicable desired deployment procedures.

An account 414 is generated by the automated deployment platform 406 of the application deployment framework 400 for managing permissions associated with the application 412 during and/or after initial deployment. For example, the account 414 may specify a group of users that can access and/or configure the application 412. As another example, the account 414 may be a non-human account used for authenticating components of the application 412 to access an API or cloud computing resource, or may be used for another security-related purpose. In embodiments where the application deployment system 410 is Kubernetes, the account 414 may be a Kubernetes ServiceAccount object.

A load balancer 416 is also configured by the automated deployment platform 406 for distributing network traffic within the application 412 after initial deployment. For example, the user 402 may specify a certain network traffic distribution in the abstracted configuration file 404 or a certain distribution may be associated with the deployment environment determined by the environmental variable, and the desired distribution is then enacted by the load balancer 416. In traditional application deployment frameworks, a user must configure the desired accounts and/or load balancers manually and independently of any configuration instructions provided to an application deployment system 410 such as Kubernetes. However, the application deployment framework 400 enables accounts 414 and load balancers 416 to be automatically generated and configured by the automated deployment platform 406 based on the same set of instructions (i.e., the abstracted configuration file 404) provided by a user to direct the application deployment system 410. Combining this automatic generation with the other automated deployment features of the automated deployment platform 406 reduces the amount of manual oversight required for application deployment and aids in the reduction of computation resources spent on configuring these multiple automated processes.

In some embodiments, the application deployment framework 400 disclosed herein automates monitoring processes performed on the application 412 after initial deployment. For example, as depicted in FIG. 4, the application deployment framework 400 includes monitoring the performance 418 of the application 412 with the automated deployment platform 406 after the application 412 is deployed by the application deployment system 410. The automated deployment platform 406 may monitor the performance 418 of the application 412 by, e.g., sending a test input to the application before sending user traffic to the application or by sending a liveness check to determine whether the application is still running after initial deployment. In some embodiments, the performance 418 is monitored for deviations from an expected performance of the application, as determined based on the direction of the deployment manifest 408 (e.g., detected deviations from the directions of the deployment manifest 408 are flagged).

Also as depicted in FIG. 4, the application deployment framework 400 includes a DNS 420, for which traffic routing 422 is monitored by the automated deployment platform 406. In some embodiments, the automated deployment platform 406 receives an indication (e.g., from the user 402) that the application 412 is associated with a domain name and propagates the domain name to the DNS 420, which associates the domain name with an internet protocol (IP) address at which the application 412 is accessible. The automated deployment platform 406 then monitors the traffic routing 422 to determine whether requests from public users to access the application 412 are deviating from an expected routing based on the domain name propagated to the DNS 420 (e.g., public users inputting the domain name in a search engine are not routed to the application 412).

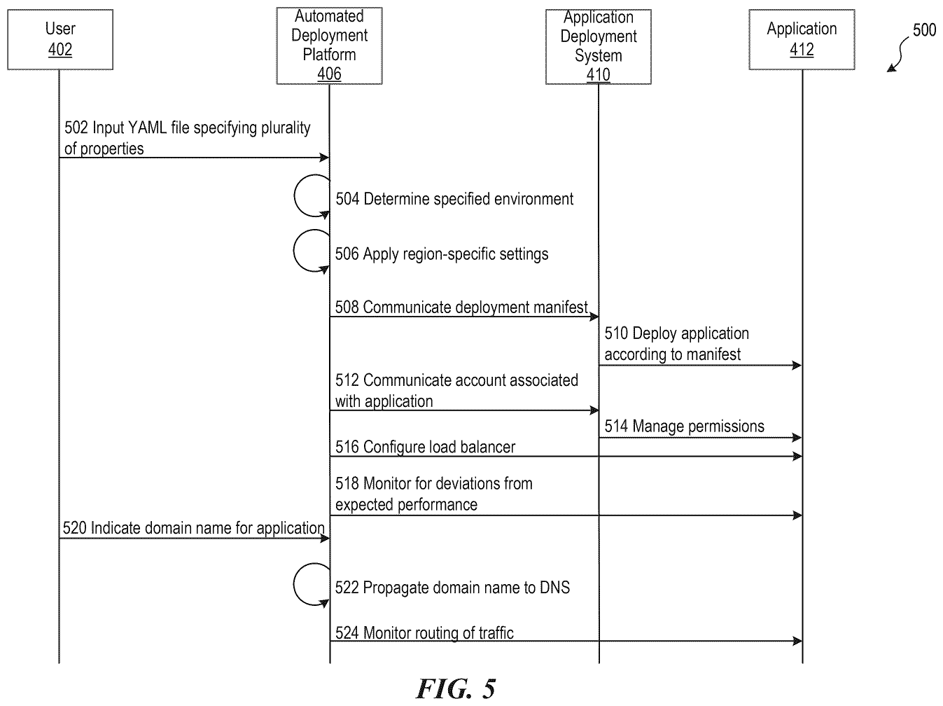

FIG. 5 is a sequence diagram illustrating an example sequence 500 for monitoring and deploying an application 412. In operation 502, a YAML file specifying a plurality of properties is input into an automated deployment platform 406 by a user 402. The YAML file is a specific example of an abstracted configuration file 404, as described in relation to FIG. 4 above. In some embodiments, the plurality of properties includes the properties described in relation to FIG. 6 below and/or an environmental variable as described in relation to FIG. 4 above.

In operation 504, the automated deployment platform 406 determines a specified environment for deploying the application. In embodiments where the plurality of properties includes an environmental variable, the environment may be determined based on at least the environmental variable. In operation 506, the automated deployment platform 406 applies region-specific settings associated with the environment. In some embodiments, these region-specific settings are reflected in a deployment manifest 408 generated by the automated deployment platform 406. Accordingly, in operation 508, a deployment manifest 408 generated by the automated deployment platform 406 is sent to an application deployment system 410 by the automated deployment platform 406. In some embodiments, the deployment manifest 408 directs the application deployment system 410 in the same or a similar manner to the manner described in relation to FIG. 4 above. In operation 510, in response to receiving the deployment manifest 408, the application deployment system 410 deploys the application 412 in accordance with the directions provided by the deployment manifest 408.

In operation 512, the automated deployment platform 406 generates an account 414 associated with the application 412 and communicates the account 414 to the application deployment system 410. As described in relation to FIG. 4, the account 414 is used for managing permissions associated with the application 412 in various security contexts. For example, in embodiments where the application deployment system 410 is Kubernetes, the account 414 may be a Kubernetes ServiceAccount object and may be used to authenticate a component of a Kubernetes cluster (e.g., when accessing the Kubernetes API server or implementing identity-based security policies). In operation 514, the application deployment system 410 manages permissions of the application 412 in accordance with the account 414.

In operation 516, a load balancer 416 for distributing network traffic within the application 412 is then configured by the automated deployment platform 406. For example, the load balancer 416 may be an application load balancer (ALB) or a network load balancer (NLB) with the properties described in relation to the load balancer 416 of FIG. 4 above.

In operation 518, the automated deployment platform 406 monitors the deployed application 412 for deviations from an expected performance. In some embodiments, the expected performance is based on the direction of the deployment manifest 408, as described in relation to FIG. 4 above, and/or may be provided by the user 402 or another entity independently of the deployment manifest 408 and compared to the actual deployment of the application 412.

In operation 520, the user 402 indicates a domain name for the application 412 to the automated deployment platform 406. The automated deployment platform 406 then automates the rest of the process of associating the application 412 with the domain name by propagating the domain name to the DNS 420 and monitoring routing of traffic to the application in operations 522 and 524, respectively. The monitoring of operation 524 includes monitoring whether requests from public users to access the application 412 deviate from an expected routing based on the domain name propagated to the DNS 420 (e.g., public users inputting the domain name in a search engine are not routed to the application 412).

### Example Abstracted Configuration File

FIG. 6 is an illustration of an example abstracted configuration file 600. As depicted in FIG. 6, the abstracted configuration file 600 is a YAML file (indicated by the .yml file extension) and includes a plurality of properties specified by a user 402; the plurality of properties includes an application type 602, a name 604, a number of replicas 606, a privacy level 608, a number of central processing units (CPUs) 610, an amount of random access memory (RAM) 612, an environmental variable 614, toleration identifiers 616, autoscaling variables 618, and monitoring variables 620. However, in other embodiments, the abstracted configuration file 600 may be written in a different data serialization language and/or include a different plurality of properties. The different plurality of properties may differ in terms of the properties included in the plurality and/or the specified values for one or more of the properties.

The application type 602 specifies the type of application 412 to be deployed by an automated deployment platform 406 receiving the abstracted configuration file 600. For example, the application type 602 may be either a job configured to run until a specified task is completed or a service configured to run for a specified or indefinite period of time.

The name 604 identifies a title to be given to the application 412 specified by the abstracted configuration file 600. In some embodiments, the name 604 is unique to the application 412 and distinguishes it from other applications that have been deployed. In these and other embodiments, the name 604 may be used as the domain name propagated to the DNS 420, which public users can use to access the application 412.

The number of replicas 606 specifies a number of replicas of the application 412 to be deployed. The privacy level 608 determines whether public users of the application can access data stored by the application. For example, the privacy level 608 may be public or private, determining that public users have direct access to a database of the application 412 or only access to an API of the application 412, respectively. The number of CPUs 610 specifies the number of CPUs to use for deployment of the application, while the amount of RAM 612 specifies the amount of RAM to use for deployment of the application. In some embodiments, the number of CPUs 610 and amount of RAM 612 are categorized together as properties pertaining to resource usage, as depicted in FIG. 6.

The environmental variable 614 corresponds to an environment in which the application 412 is to be deployed, as described in relation to FIG. 4 above. As depicted in FIG. 6, the environmental variable is “prod,” which corresponds to a production environment for deploying the application 412. In some embodiments, the environmental variable 614 affects the application of other variables during deployment of the application 412, as described in more detail below.

The toleration identifiers 616 specify a group of nodes within the application deployment system 410 to use for deploying the application. For example, the application type 602 or the environment specified by the environmental variable 614 may be associated with the use of a certain group of nodes (e.g., by configuration of the user or a project manager).

The autoscaling variables 618 specify a minimum and maximum number of copies of the application to be deployed based on the environmental variable 614. For example, as depicted in FIG. 6, the autoscaling variables are categorized in two groups, a “dev” group and a “prod” group, corresponding to a development environment and production environment, respectively. Because “prod” has been input as the environmental variable 614, the minimum and maximum in the “prod” group will be applied during deployment of the application 412.

The monitoring variables 620 specify various frequencies with which the application is monitored by the automated deployment platform 406 after deployment. For example, a monitoring variable 620 may be related to the readiness of the application 412 to receive traffic (e.g., specify an initial delay before an application 412 receives traffic, a period in seconds between checks for readiness, a number of failures to receive a response from the application 412 regarding readiness after which the automated deployment platform 406 will treat the application 412 as failed, or a number of responses received from the application 412 after which the automated deployment platform 406 will treat the application 412 as ready to receive traffic). A monitoring variable 620 may also relate to the liveness of the application 412 (e.g., specify a period in seconds between checks for liveness, a number of failures to receive a response from the application 412 regarding liveness after which the automated deployment platform 406 will treat the application 412 as failed, or a number of responses received from the application 412 after which the automated deployment platform 406 will treat the application 412 as live).

### Example Method of Application Deployment Management

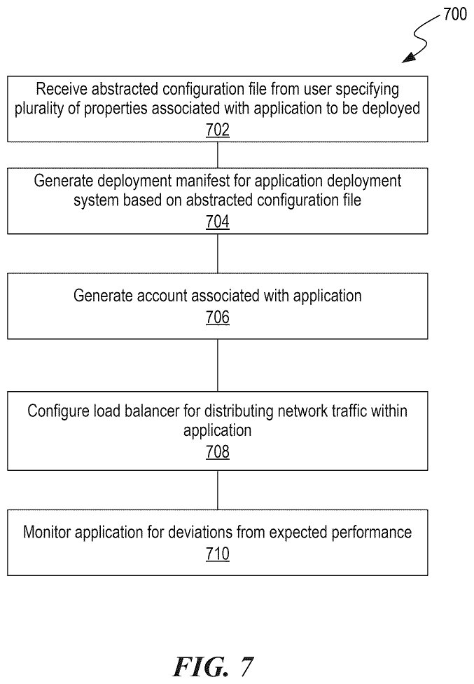

FIG. 7 is a flow diagram illustrating an example method for management of application deployment 700. Operations 702 and 704 enable a user seeking to deploy an application to do so without manually operating an application deployment system and configuring the relevant parameters individually. In operation 702, an abstracted configuration file is received from a user specifying a plurality of properties associated with an application to be deployed. In some embodiments, the abstracted configuration file is a YAML file or other data serialization file specifying a plurality of properties including the properties described in relation to FIG. 6 above, and/or other properties. In operation 704, a deployment manifest is generated for an application deployment system based on the abstracted configuration file. In some embodiments, the deployment manifest is generated by translating the abstracted configuration file using an automated deployment platform, as described in relation to FIG. 4 above. In these and other embodiments, the deployment manifest directs the application deployment system in the same or a similar manner to the manner described in relation to FIG. 4 above.

Operations 706-710 enable deployment and monitoring processes falling outside the purview of the application deployment system to likewise be managed without manual configuration by the user. In operation 706, an account associated with the application is generated. In some embodiments, the account may be the same or generally similar to the account described in relation to FIG. 4 above. In operation 708, a load balancer for distributing network traffic within the application is configured. In some embodiments, the load balancer may be the same or generally similar to the load balancer described in relation to FIG. 4 above. In operation 710, the application is monitored for deviations from an expected performance. In some embodiments, the application is monitored by the automated deployment platform, in the same or generally a similar manner as the manner described in relation to FIG. 4 above. In these and other embodiments, the expected performance is determined based on the direction of the deployment manifest and/or is independently provided by the user or another entity.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions recorded thereon, wherein the instructions, when executed by at least one data processor of a system, cause the system to:
receive an abstracted configuration file from a user specifying a plurality of properties associated with an application to be deployed by an application deployment system,
wherein the plurality of properties includes an environmental variable indicating whether the application is to be deployed in a development environment, a staging environment, or a production environment;
determine an environment based on at least the environmental variable specified by the abstracted configuration file,
wherein the environment is a cloud data center located in a specific geographic location and used by the application deployment system to deploy the application;
generate, based on the abstracted configuration file, a deployment manifest for the application deployment system,
wherein the deployment manifest directs the application deployment system to modify the application from a current state to a desired state at a controlled rate,
wherein the deployment manifest defines parameters for a container in the application deployment system, the parameters including at least one of an image, a port, an environmental variable, or a security context, and
wherein the deployment manifest specifies a deployment policy for the application deployment system, the deployment policy being at least one of a resource limit or a scaling policy;
apply region-specific settings associated with the environment to the application deployment system;
generate an account associated with the application deployed by the application deployment system,
wherein the account is used to manage permissions associated with the application;
configure a load balancer for distributing network traffic within the application based on the environment;
monitor the application for deviations from an expected performance of the application,
wherein the expected performance is based on the direction of the deployment manifest, and
wherein said monitoring includes at least one of sending a test input to the application before sending user traffic to the application or sending a liveness check to determine whether the application is still running after initial deployment;
upon receiving an indication that the application is associated with a domain name, propagate the domain name to a domain name system (DNS); and
monitor routing of traffic from public users to the application for deviations from an expected routing based on the domain name propagated to the DNS.

2. The non-transitory, computer-readable storage medium of claim 1, wherein:
the abstracted configuration file is a YAML file specifying a plurality of properties associated with an application including:
the environmental variable;
a name for the application;
a number of replicas of the application to deploy;
a number of central processing units (CPUs) to use for deployment of the application;
an amount of random access memory (RAM) to use for deployment of the application;
a toleration identifier specifying a group of nodes within the application deployment system to use for deploying the application;
an autoscaling variable specifying a minimum and maximum number of copies of the application to be deployed based on the environmental variable;
a privacy level determining whether public users of the application can access data stored by the application;
a time delay applied between deployment of the application and the application being accessible by public users; and
a monitoring variable specifying a frequency with which the application is monitored after deployment.

3. The non-transitory, computer-readable storage medium of claim 1, wherein:
the application deployment system is Kubernetes.

4. The non-transitory, computer-readable storage medium of claim 1, wherein:
the application deployed by the application deployment system is either a job configured to run until a specified task is completed or a service configured to run for a specified or indefinite period of time.

5. A system comprising:
at least one hardware processor; and
at least one non-transitory memory storing instructions, which, when executed by the at least one hardware processor, cause the system to:
receive an abstracted configuration file from a user specifying a plurality of properties associated with an application to be deployed by an application deployment system;
based on the abstracted configuration file, generate a deployment manifest for the application deployment system,
wherein the deployment manifest directs the application deployment system to modify the application from a current state to a desired state at a controlled rate;
generate an account associated with the application deployed by the application deployment system,
wherein the account is used to manage permissions associated with the application;
configure a load balancer for distributing network traffic within the application; and
monitor the application for deviations from an expected performance of the application,
wherein the expected performance is based on the direction of the deployment manifest.

6. The system of claim 5, further comprising instructions causing the system to:
determine an environment based on at least an environmental variable specified by the abstracted configuration file,
wherein the environmental variable indicates whether the application is to be deployed in a development environment, a staging environment, or a production environment, and
wherein the environment is a cloud data center located in a specific geographic location and used by the application deployment system to deploy the application; and
apply region-specific settings associated with the environment to the application deployment system.

7. The system of claim 5, wherein:
the deployment manifest defines parameters for a container in the application deployment system, the parameters including at least one of an image, a port, an environmental variable, or a security context; and
wherein the deployment manifest specifies a deployment policy for the application deployment system, the deployment policy being at least one of a resource limit or a scaling policy.

8. The system of claim 5, further comprising instructions causing the system to:
upon receiving an indication that the application is associated with a domain name, propagate the domain name to a domain name system (DNS); and
monitor routing of traffic from public users to the application for deviations from an expected routing based on the domain name propagated to the DNS.

9. The system of claim 5, wherein:
the abstracted configuration file is a YAML file specifying a plurality of properties associated with an application.

10. The system of claim 9, wherein the plurality of properties includes:
an environmental variable;
a name for the application;
a number of replicas of the application to deploy;
a number of central processing units (CPUs) to use for deployment of the application;
an amount of random access memory (RAM) to use for deployment of the application;
a toleration identifier specifying a group of nodes within the application deployment system to use for deploying the application;
an autoscaling variable specifying a minimum and maximum number of copies of the application to be deployed based on the environmental variable;
a privacy level determining whether public users of the application can access data stored by the application;
a time delay applied between deployment of the application and the application being accessible by public users; and
a monitoring variable specifying a frequency with which the application is monitored after deployment.

11. The system of claim 5, wherein:
the application deployment system is Kubernetes.

12. The system of claim 5, wherein:
the application deployed by the application deployment system is either a job configured to run until a specified task is completed or a service configured to run for a specified or indefinite period of time.

13. A method comprising:
receiving an abstracted configuration file from a user specifying a plurality of properties associated with an application to be deployed by an application deployment system;
generating, based on the abstracted configuration file, a deployment manifest for the application deployment system,
wherein the deployment manifest directs the application deployment system to modify the application from a current state to a desired state at a controlled rate;
based on the abstracted configuration file, generating an account associated with the application deployed by the application deployment system,
wherein the account is used to manage permissions associated with the application;
configuring a load balancer for distributing network traffic within the application; and
monitoring the application for deviations from an expected performance of the application,
wherein the expected performance is based on the direction of the deployment manifest.

14. The method of claim 13, further comprising:
determining an environment based on at least an environmental variable specified by the abstracted configuration file,
wherein the environmental variable indicates whether the application is to be deployed in a development environment, a staging environment, or a production environment, and
wherein the environment is a cloud data center located in a specific geographic location and used by the application deployment system to deploy the application; and
applying region-specific settings associated with the environment to the application deployment system.

15. The method of claim 13, wherein:
the deployment manifest defines parameters for a container in the application deployment system, the parameters including at least one of an image, a port, an environmental variable, or a security context; and
wherein the deployment manifest specifies a deployment policy for the application deployment system, the deployment policy being at least one of a resource limit or a scaling policy.

16. The method of claim 13, further comprising:
upon receiving an indication that the application is associated with a domain name, propagating the domain name to a domain name system (DNS); and
monitoring routing of traffic from public users to the application for deviations from an expected routing based on the domain name propagated to the DNS.

17. The method of claim 13, wherein:
the abstracted configuration file is a YAML file specifying a plurality of properties associated with an application.

18. The method of claim 17, wherein the plurality of properties includes:
an environmental variable;
a name for the application;
a number of replicas of the application to deploy;
a number of central processing units (CPUs) to use for deployment of the application;
an amount of random access memory (RAM) to use for deployment of the application;
a toleration identifier specifying a group of nodes within the application deployment system to use for deploying the application;
an autoscaling variable specifying a minimum and maximum number of copies of the application to be deployed based on the environmental variable;
a privacy level determining whether public users of the application can access data stored by the application;
a time delay applied between deployment of the application and the application being accessible by public users; and
a monitoring variable specifying a frequency with which the application is monitored after deployment.

19. The method of claim 13, wherein:
the application deployment system is Kubernetes.

20. The method of claim 13, wherein:
the application deployed by the application deployment system is either a job configured to run until a specified task is completed or a service configured to run for a specified or indefinite period of time.
